(19) United States
(12) Patent Application Publication
(10) Pub. No.: US 2003/0067260 A1
(43) Pub. Date: Apr. 10, 2003

(54) Flat light

(76) Inventor: Donald J.E. Miller JR., Tampa, FL (US)

Correspondence Address: Donald J. E. Miller, Jr., 6509 Secrest Ct, Tampa, FL, 33625, US

(21) Appl. No.: 09/973,543

(22) Filed: Oct. 9, 2001

(51) Int. Cl. H01J 17/16

(52) U.S. Cl. 313/317; 313/634

(57) ABSTRACT

Flat Light is a light bulb triangular in shape with a flat top, and its brother has a reflecting cover on the bottom to send out more light through the side and top.

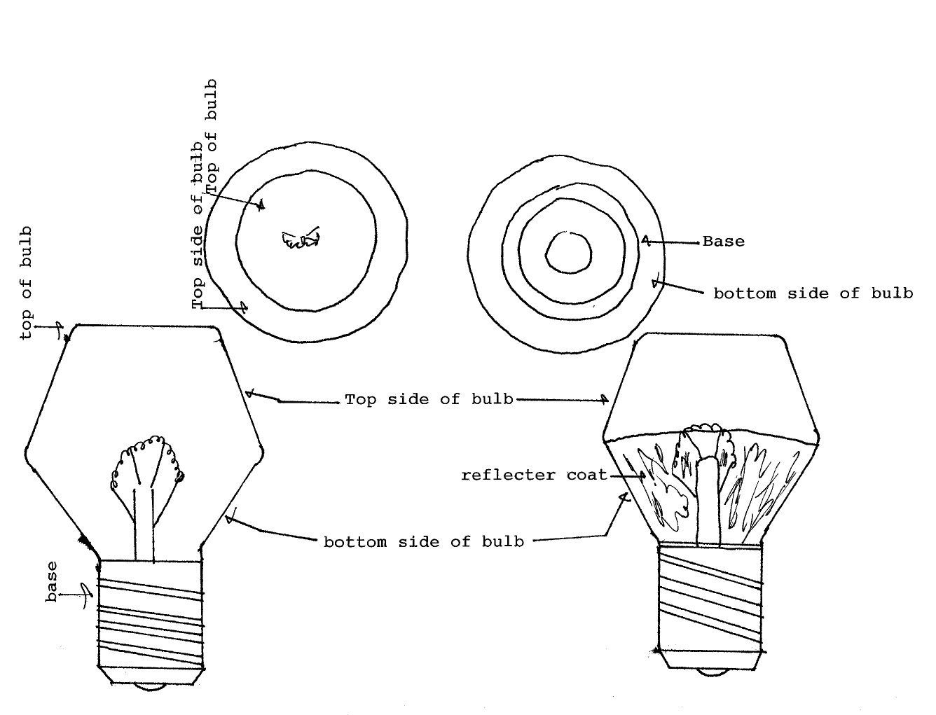

### BACKGROUND

Field: This invention relates to light bulbs.

Information: Flat light is designed to maximize the light it gives out, by being triangular shaped and having no neck the light that it gives off is not wasted and is put to full use. The second version of flat light with the reflecter is used when more direct light is needed, because instead of the light coming from the bottom of the bulb it's directed out the top and sides of the bulb like a spot light or flash light dos.

### SUMMARY

The flat light can be used like any standard light bulb is used. But not like the standard light bulb when a regular bulb is on it lights up the round part of the bulb and tries to light up the neck also, that is wasted light. But the flat light has no neck so the light that it gives off is used in the bulb and not in a space like the neck. The reflector version of the flat light is used in places like out side lamps where more light is needed to the side and down like a spot light.

### DESCRIPTION OF DRAWINGS

1. Shows different views and versions of Flat Light.

### DESCRIPTION OF INVENTION

The Flat Light measures approximately 4⅜″ long from the top of the bulb to the bottom of the base, and approximately 2½″ Wide. The bulb measures approximately 2¼″ long and approximately 7½″ around, the top will be aproximately 2″ wide. The bottom of the bulb will slant out at approximately a 50-degree angle and the sides will slant in at approximately an 80-degree angle, and the corners of the bulb are slightly rounded and not pointed. The reflector bulb will measure the same, but it will have a reflecter coating on the bottom of the bulb and this will direct the light out to the sides and top of the bulb. Flat Light will come in veriase sizes, colors and wattage.

1. I claim Flat Light, as described herein specifications and in the drawings, a light bulb triangular in shape with a flat top and round corners and no long neck, and its second version with the reflector coating on the bottom.
